(19) United States
(12) Patent Application Publication
(10) Pub. No.: US 2008/0070101 A1
(43) Pub. Date: Mar. 20, 2008

(54) FOIL CELL FILL PORT

(76) Inventor: Joseph Barrella, Yonkers, NY (US)

Correspondence Address: ISRAEL NISSENBAUM, 1038-56TH ST, BROOKLYN, NY, 11219, US

(21) Appl. No.: 11/532,082

(22) Filed: Sep. 14, 2006

(51) Int. Cl. H01M 2/36; H01M 2/08

(52) U.S. Cl. 429/72; 429/185

(57) ABSTRACT

A method for filling foil container electrochemical cells with fluid electrolyte and an integral structure for such foil container cells which permits such method. In accordance with the present invention, a fill port or fill header member is integrated with a fluid tight seal with a peripheral seal of the cell container and remains as a part of the cell. The fill port comprises a member for the fluid introduction therethrough of fluid electrolyte to the cells and the fluid tight sealing thereof thereafter.

### FIELD OF THE INVENTION

This invention relates to flexible foil type electrochemical cells and methods for the expedited filling of such cells with fluid electrolytes.

### BACKGROUND OF THE INVENTION

For maximum utilization flexibility, with space considerations, high energy density cells such as lithium ion and lithium polymer cells have been constructed in foil cell package or pouch configurations. These cells generally comprise flat layers of electrodes, i.e., anodes and cathodes with separators interposed therebetween. The layered electrode and separator materials are placed between foil laminate (metal with both sides being coated with plastic layers) materials which are superimposed on each other and peripherally heat sealed to form a cell container. Metal terminal tabs, attached to the anodes and cathodes respectively, or more properly, the metal base substrates (expanded metal or foil) for the electrode materials, extend through the heat seals for exterior electrical connection. In order to ensure fluid tightness, the metal terminal tabs are coated (both sides) in a limited area, with a plastic layer, to also effect a heat seal with the foil laminates at their points of contact with the heat seal area. Fluid electrolyte is introduced to the cell through an unsealed side prior to sealing, with a vacuum being drawn through the unsealed side prior to the sealing. A fill tube through which the electrolyte is introduced is also used to introduce the vacuum. The fill tube is removed and the heat seal is finalized to seal the cell. The fill process during the heat sealing is however awkward and cumbersome and is subject to quality control problems.

### SUMMARY OF THE INVENTION

It is therefore an object of the present invention to provide an improved method and device for the filling of foil type electrochemical cells with fluid electrolyte.

It is a further object of the present invention to provide the foil type electrochemical cells with an integrated fluid fill tube which remains as part of the cell structure.

It is yet another object of the present invention to provide said fill tube of a polymeric heat sealable material whereby it is integrated as part of the cell heat seal and through which the electrolyte is filled and the vacuum drawn.

These and other objects, features and advantages of the present invention will become more evident from the following discussion and drawings in which:

### SHORT DESCRIPTION OF THE DRAWINGS

FIG. 1 is an isometric view of a foil container electrochemical cell with an integrated fill port or header.

FIG. 2 is a front view of the cell of FIG. 1, showing the contents and heat seal periphery in dotted line; and

FIGS. 3a and 3b show cross sections of the fill port, as initially sealed, and with introduction of an electrolyte through a fill needle respectively.

### DETAILED DESCRIPTION OF THE INVENTION

Generally the present invention comprises a method for filling foil container electrochemical cells with fluid electrolyte and an integral structure for such foil container cells which permits such method. In accordance with the present invention, a fill port or fill header member is integrated with a fluid tight seal with a peripheral seal of the cell container and remains as a part of the cell. The fill port comprises means for the fluid introduction therethrough of fluid electrolyte to the cells and the fluid tight sealing thereof thereafter. It is preferred that such fill port also be adapted to serve for the introduction of a vacuum into the cell for removal of residual air and gas from the cell prior to sealing. It is preferred that the fill port be sealed prior to the introduction of the electrolyte whereby dry inactive cells can be stored or processed prior to electrolyte activation.

It is preferred that the fill port be comprised of an electrolyte inert heat sealable polymeric material such as polypropylene whereby it can readily heat sealed with the foil heat seal and wherein it can be closed with a heat seal. In a preferred embodiment the fill port is coextensive with the heat seal section of the foil container and does not protrude into the cell interior. It is also preferred that fill port have a somewhat peripherally extended filling section to facilitate filling with a filling needle by providing means for supporting engagement with a fixture, and that the fill port is provided with ramped sections in a diamond configuration around the central fill port to provide a gradual and separation resistant head seal with the peripheral edges of the foil container. In this regard it is similar in configuration to the openable nozzles used in commercially available Flavia® coffee and tea packages such as disclosed in U.S. Pat. No 6,358,545, which are used to receive hollow needle water injectors when a beverage is to be produced.

It is further preferred that the fill port, when sealed into the foil cell container, is itself initially sealed with a pierceable membrane whereby placement thereof in the cell provides a fully sealed container. This enables the production of completed “dry” cells which can be stored for later activation when needed, with the introduction of electrolyte. When electrolyte is to be introduced, the membrane is pierced and the fluid electrolyte is dispensed into the cell and a vacuum drawn to remove residual air and gases. Closure and heat sealing of the fill port thereafter is preferably effected by insertion of a polymeric plug and heat sealing it in place.

### DETAILED DESCRIPTION OF THE DRAWINGS

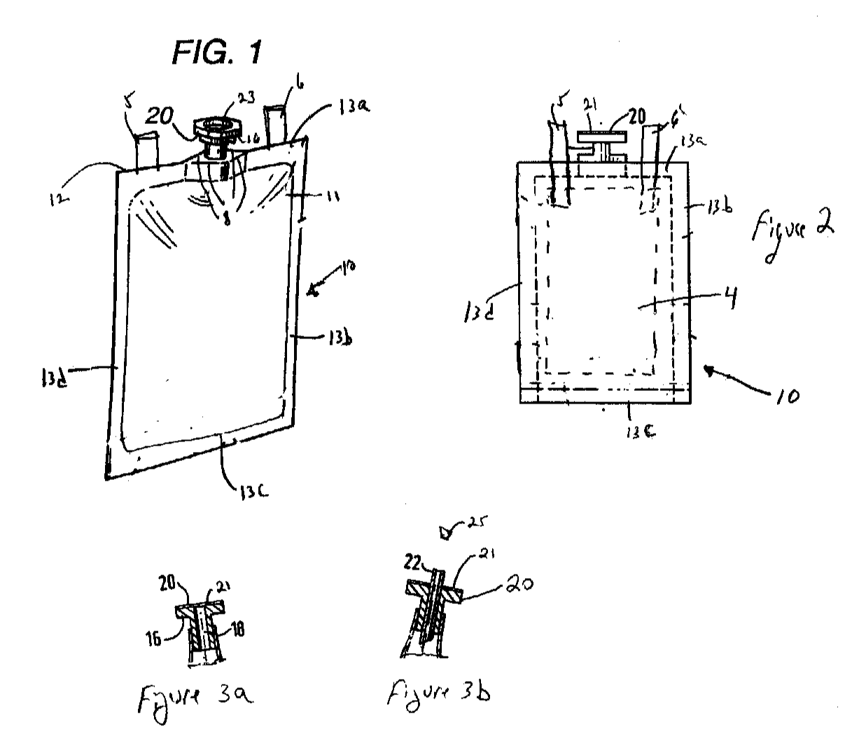

With specific reference to the drawings the foil cell container 10 of FIG. 1 is formed of two face-to-face laminates 11 and 12. Each laminate consists of an outer polymer layer such as a polyester layer, an intermediate aluminum layer and an inner polypropylene layer. The inner polyethylene laminates are heat bonded together at the edges 13a-d. A polypropylene fill port 20 is positioned and heat sealed within the top edge heat seal 13a of the container. As indicated in FIG. 2, the fill port 20 extends only across the depth of the heat seal at 13a. Terminal tabs 5 and 6 are attached to anode and cathode elements within cell stack 4 respectively and form part of the seal at 13a as seen in FIG. 2. Ramped edges 8 which form a diamond shape provide a gradual and extended seal between the fill port 20 and laminates 11 and 12 to ensure fluid tight sealing integrity.

As seen in the Figures, the fill port 20 is initially provided with a pierceable membrane 21 (FIGS. 2 and 3a). This membrane is pierced by fluid electrolyte injection needle 22, shown in FIG. 3b, with said needle passing through aperture 23 and being guided into position by ledge extension 16 which also provide reinforcement against the forces of the needle insertion. Ledge 16 is adapted to engage a fixture and to hold the container in place during electrolyte filling. Plug 25 is placed in aperture 23 after removal of needle 22 and heat sealed in place in order reseal the cell.

It is understood that the above description and drawings are exemplary of the present invention and that changes in procedure and structure as well as cell components is possible without departing from the scope of the present invention as defined in the following claims.

What is claimed is:

1) An electrochemical cell enclosed in sealed foil container comprised of two laminate sheets superimposed on each other and sealed to each other at the peripheral edges thereof, wherein a fill port element is sealed within a portion of said peripheral seal whereby a fluid electrolyte is able to be introduced to said cell through said fill port element and wherein the fill port element is sealingly closed thereafter and remains as part of the seal of said cell.
